(19) United States
(12) Patent Application Publication
(10) Pub. No.: US 2017/0325615 A1
(43) Pub. Date: Nov. 16, 2017

(54) KITCHEN UTENSIL

(71) Applicant: KABUSHIKI KAISYA LEBEN HANBAI, Kanagawa (JP)

(72) Inventor: Atsushi TAKABU, Kanagawa (JP)

(21) Appl. No.: 15/527,980

(22) PCT Filed: Nov. 11, 2015
(86) PCT No.: PCT/JP2015/081784

§ 371 Date: May 18, 2017

(30) Foreign Application Priority Data
Nov. 19, 2014 (JP) 2014-234686

(51) Int. Cl. A47J 17/02; A47J 43/28; A47J 43/25; A47J 17/00; A47J 43/00

(52) U.S. Cl. CPC A47J 17/02; A47J 43/288; A47J 43/25; A47J 43/00; A47J 17/00

(57) ABSTRACT

Provided is a kitchen utensil which can respond to an object having any shape. A kitchen utensil (10) according to the present invention has a holding portion (12) and a blade member (15) having a blade (17) supported by the holding portion, and the blade is protruded forward of the holding portion.

### TECHNICAL FIELD

The present invention relates to a kitchen utensil. The present invention claims the benefit of priority to Japanese Patent Application No. 2014-234686 filed on Nov. 19, 2014, the entire contents of which are incorporated herein by reference in designated states where the incorporation of documents by reference is approved.

### BACKGROUND ART

Conventionally, manual peeling utensils (peelers) are known to peel the skins of vegetables, fruits, and the like. Such a peeling utensil includes a blade having a shape capable of thinly peeling a skin just by being moved along a material.

In most of such peeling utensils, the blade is generally held and fixed to a substantially Y-shaped member. However, in the peeling utensils of such a structure, a holding portion for the blade is conventionally positioned ahead of the blade. Thus, when such a peeling utensil is used for a flat food or the like, there has been a possibility that the holding portion being protruded hinders application of the blade to an object, and the flat food cannot be peeled well (for example, Patent Document 1).

### CITATION LIST

### Patent Literature

Patent Literature 1: JP 2010-104400 A

### SUMMARY OF INVENTION

### Technical Problem

Accordingly, it is an object of the present invention to provide a kitchen utensil which can respond to an object having any shape.

### Solution to Problem

In order to solve the above-described problems, a kitchen utensil according to the present invention includes a holding portion and a blade member having a blade supported by the holding portion, in which the blade protruded forward of the holding portion.

Furthermore, the blade member may have an upper section and a lower section positioned substantially parallel and having a difference in level, and the upper section may be protruded forward of the lower section.

Furthermore, the blade member may include a blade at the upper section.

Furthermore, the blade member may further include a blade at the lower section.

Furthermore, the blades may have any one of a blade on a flat surface, raised teeth, and a corrugated blade.

Furthermore, the raised teeth may be arranged in a plurality of raised tooth rows to be alternately aligned.

Furthermore, the blade at the upper section may have a blade on a flat surface, and the blade at the lower section may have raised teeth.

Furthermore, the raised teeth at the lower section may be protruded forwardmost as a whole.

Furthermore, the blade member having a flat blade and the blade member having raised teeth may be supported opposite to each other with the blades facing outward.

Furthermore, the upper and lower sections may be curved forward or backward.

### Advantageous Effects of Invention

According to the present invention, it is possible to provide a kitchen utensil which can respond to an object having any shape.

### BRIEF DESCRIPTION OF DRAWINGS

FIG. 1 is a perspective view of a kitchen utensil 10 according to a first embodiment of the present invention.

FIG. 2A is a front view of the kitchen utensil 10, and FIG. 2B is a side view of the kitchen utensil 10.

FIG. 3 is a cross-sectional view of a blade member 15 of the kitchen utensil 10.

FIG. 4 is an explanatory diagram illustrating use of the kitchen utensil 10.

FIG. 5 is a perspective view of a kitchen utensil 20 according to a second embodiment of the present invention.

FIG. 6 is a cross-sectional view of a blade member 25 of the kitchen utensil 20.

FIG. 7 is a perspective view of a kitchen utensil 30 according to a third embodiment of the present invention.

FIG. 8 is a perspective view of a kitchen utensil 40 according to a fourth embodiment of the present invention.

FIG. 9 is a side view of the kitchen utensil 40.

FIG. 10 is a perspective view of a kitchen utensil 10a according to a first modification of the present invention.

FIG. 11 is a perspective view of a kitchen utensil 10b according to a second modification of the present invention.

FIG. 12A is a perspective view of a kitchen utensil 10c according to a third modification of the present invention. FIG. 12B is a cross-sectional view of an object obtained by using the kitchen utensil 10c.

### DESCRIPTION OF EMBODIMENTS

Embodiments of the present invention will be described below with reference to the drawings.

### First Embodiment

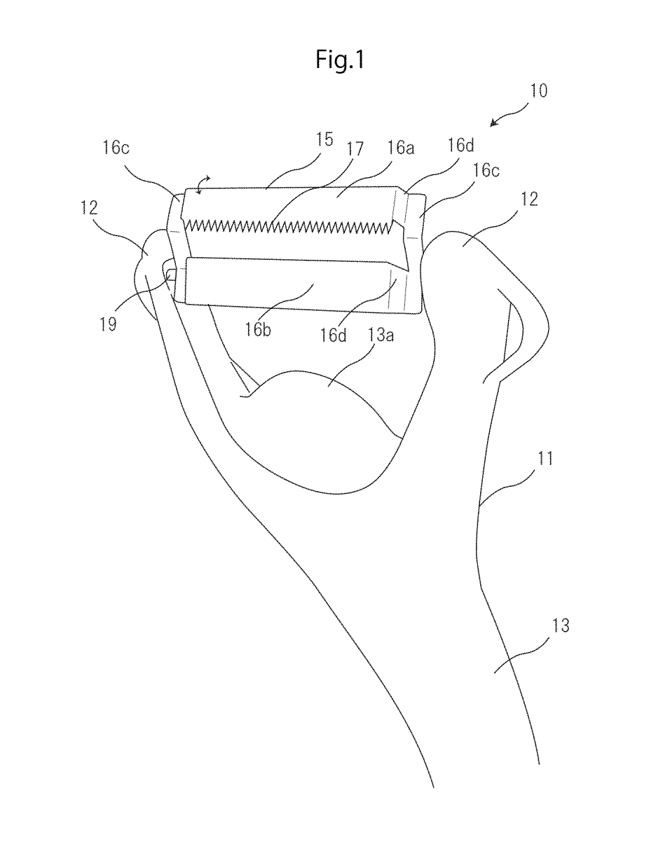

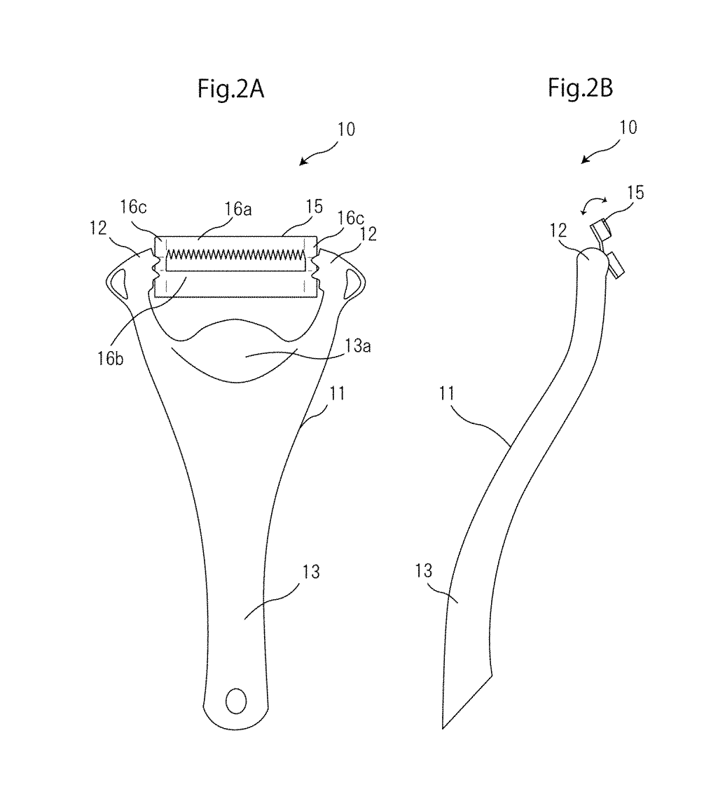

FIG. 1 is a perspective view of a kitchen utensil 10 according to a first embodiment of the present invention. FIGS. 2A and 2B are a front view and a side view of the kitchen utensil 10.

As illustrated in FIG. 1, the kitchen utensil 10 according to an embodiment of the present invention includes a Y-shaped member 11 and a blade member 15.

The Y-shaped member 11 of the kitchen utensil 10 includes a holding portion 12 and a grip portion 13. Note that, as illustrated in FIG. 2B, the Y-shaped member 11 is curved in a wavy shape from the grip portion 13 to the holding portion 12. When the grip portion 13 is gripped, a forefinger or a thumb is applied to a finger pad 13a which is a recess in the center, and a force is easily transmitted to an object. Note that the Y-shaped member 11 is made of, for example, a resin material. Specifically, the Y-shaped member 11 can be integrally molded from a plastic resin such as ABS resin, polypropylene resin, or the like. Note that the Y-shaped member 11 may be formed of a stainless steel plate or the like, and is not limited to the shape described herein.

The holding portion 12 of the Y-shaped member 11 is bifurcated into two from an end of the grip portion 13 and each formed in a rod shape. The holding portions 12 holds the blade member 15 therebetween through shaft members 19 formed at both ends and the blade member is swingably supported. Note that the term “swing” as used herein means slight turning of the blade member 15 by a predetermined angle about connection portions (shaft members 19) between the blade member 15 and the holding portions 12, as a rotation center. Such movement allows smooth movement of the blade along the object.

The blade member 15 has an upper section 16a and a lower section 16b each having a substantially rectangular shape, and a serrated blade 17 is formed at the upper section 16a. Note that the upper section 16a and the lower section 16b are integrally connected by connecting portions 16c formed at both ends in a longitudinal direction, and each of the connecting portions 16c has a stepwise or substantially S-shaped cross section. Accordingly, the respective sections are held substantially parallel to have a difference in level so that a flat surface of the upper section 16a is located forward (on a front side (a side to be applied to the object) and a flat surface of the lower section 16b is located backward. Furthermore, the blade member 15 is provided with steps 16d for protruding the upper section 16a and the lower section 16b forward of the connecting portions 16c and the Y-shaped member 11. Therefore, the blade 17 is positioned forwardmost as a whole in the kitchen utensil 10.

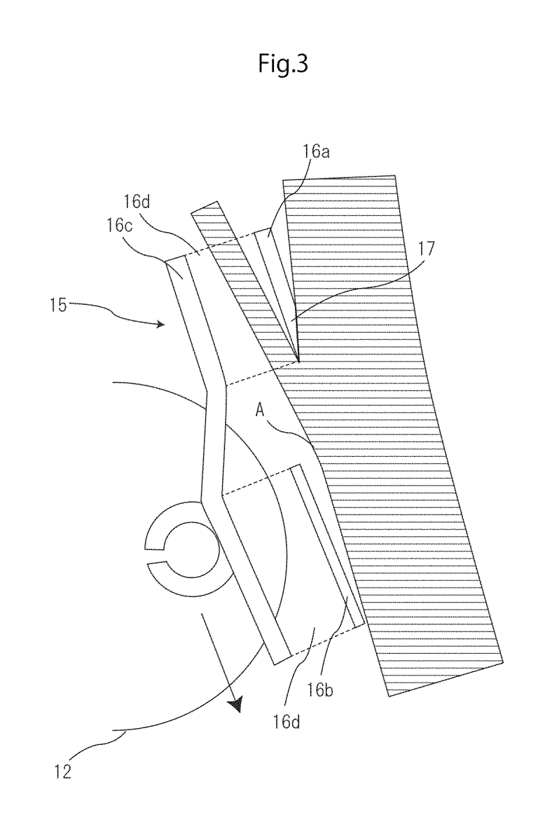

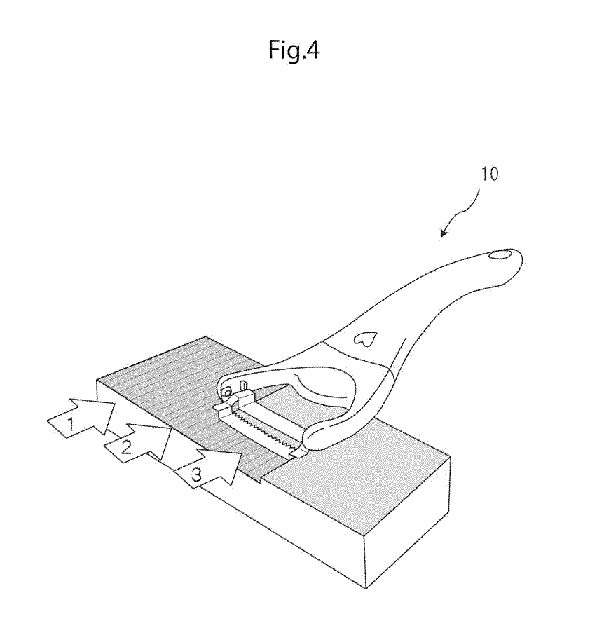

FIG. 3 is a cross-sectional view of the blade member 15, and FIG. 4 is an explanatory diagram for illustrating use of the kitchen utensil 10. As illustrated, in a case where the blade member 15 is applied to a contact surface A of the object, since the upper section 16a and the lower section 16b are protruded forward of each holding portion 12 of the Y-shaped member 11, only the blade member 15 is brought into contact with the contact surface of the object. Furthermore, since the blade 17 is protruded forward of each connecting portion 16c, application of the blade 17 is not hindered by the connecting portion 16c, preventing floating of the blade 17 from the contact surface A. Therefore, even in a case where the contact surface A is larger than a space between the holding portions 12 as illustrated in FIG. 4, uniform and deep cuts can be made, and the object can be shaved off in order from an end.

Note that the blade 17 may not have the serrated shape, and may have a plain blade, a corrugated blade, or the like. Any material may be used for the blade member as long as the material can be used for a blade. In the present example, for example, cutlery steel such as stainless steel or carbon steel, ceramic, and the like may be used. In general, the cutlery steel such as stainless steel or carbon steel is subjected to punching, press molding, quenching, and sharpening. The blade member 15 may be bent in cross-section upon press molding. Furthermore, although each blade may have any width, reduction in width enables reduction in force required in use. Furthermore, even a blunt blade is easy to use and safe. Furthermore, the reduced widths of the upper section 16a the lower section 16b can appropriately determine the widths thereof according to usage. In addition, the upper section 16a and the lower section 16b have a flat-shaped cross-section here, but may have a curved cross-section.

### Second Embodiment

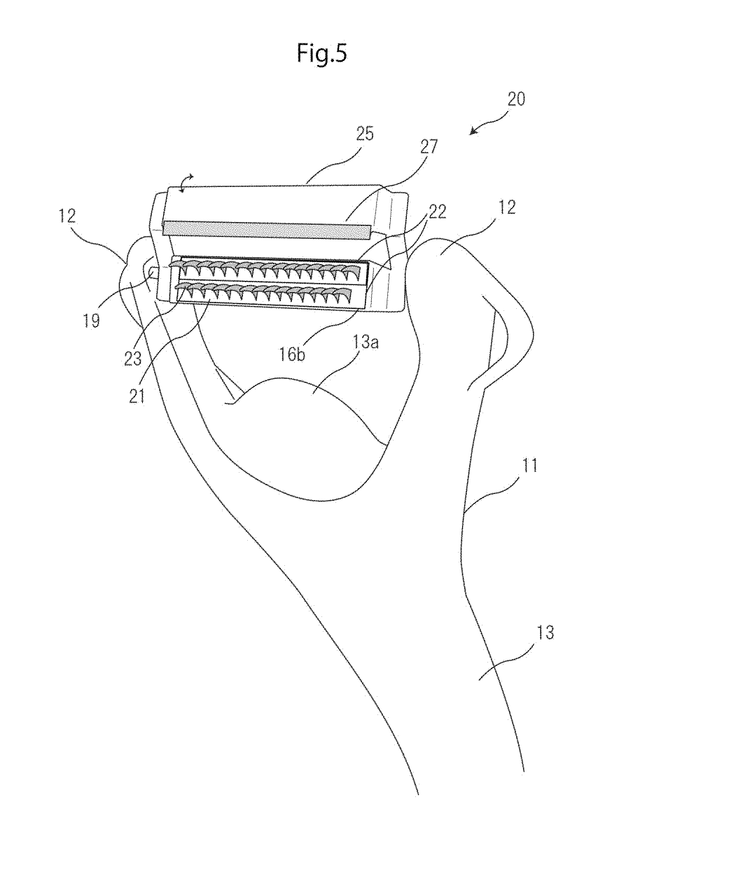

Next, a second embodiment of the present invention will be described. FIG. 5 is a perspective view of a kitchen utensil 20 according to the second embodiment of the present invention. The kitchen utensil 20 according to the present embodiment is different from the kitchen utensil of the above embodiment in that the upper section 16a includes a blade 27 and the lower section 16b includes a blade 22. Configurations similar to those of the above embodiment are denoted by similar reference signs, and a detailed description thereof will be omitted.

The kitchen utensil 20 has the blade 27 at the upper section 16a and the blade 22 at the lower section 16b. As illustrated in FIG. 5, the blade 27 formed at the upper section 16a is a straight plain blade. In contrast, the blade 22 includes a plurality of sickle-shaped raised teeth 23 standing substantially perpendicular to a blade plate 21 which is a rectangular plate piece. Note that the raised teeth 23 can be formed by making a plurality of notches obliquely in a long side of the blade plate 21 and raising the notched portions forward. Furthermore, each of the raised teeth 23 preferably has a length large enough to be positioned forward of the upper section 16a. Therefore, the raised teeth 23 are positioned forwardmost as a whole in the kitchen utensil 20.

Furthermore, here, the lower section 16b includes two rows of blades 22, and the rows have raised tooth groups respectively so that the positions of the raised teeth 23 of the raised tooth group in the first row are shifted from the positions of the raised teeth 23 of the raised tooth group in the second row. Such a two-blade structure can have a cutting width which is half of that of a single blade structure. Note that the two rows may not be necessarily included, one row may be employed, and three or more of rows of raised tooth groups may further be included. Furthermore, the raised teeth may be vertically staggered. Cut lines having a desired width therebetween are preferably made, and the width between the cut lines may be changed by, for example, alternately changing the intervals between the raised teeth.

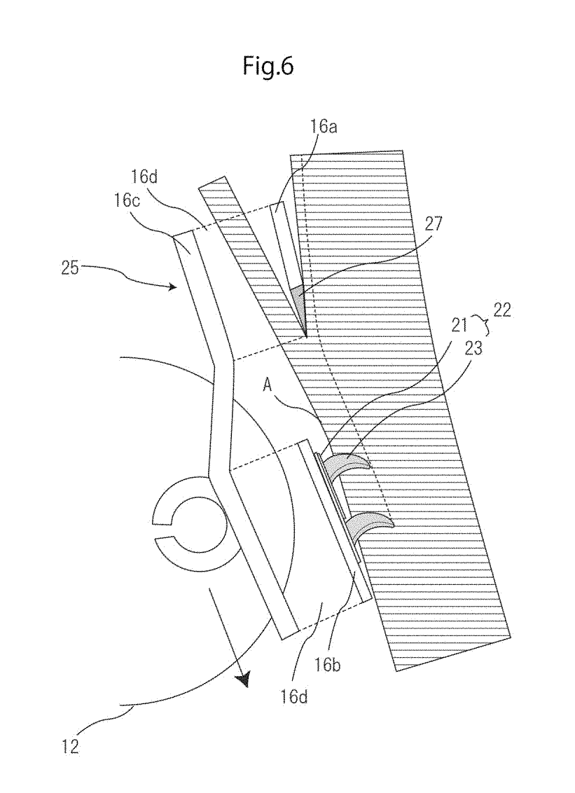

FIG. 6 is an explanatory diagram for illustrating use of the kitchen utensil 20. As illustrated, since the upper section 16a and the lower section 16b are protruded forward of each holding portion 12 of the Y-shaped member 11, application of the blade 17 and the blades 22 is not hindered by the holding portion 12. Furthermore, since the raised teeth 23 is protruded forward of the upper section 16a and each connecting portion 16c, the raised teeth 23 can be put deep under a contact surface A. An object in which cuts are made by such raised teeth 23 is shaved by the blade 27, and shredded and discharged rearward.

In addition, each raised tooth may not have a sickle shape, and may have a triangular shape or the like.

### Third Embodiment

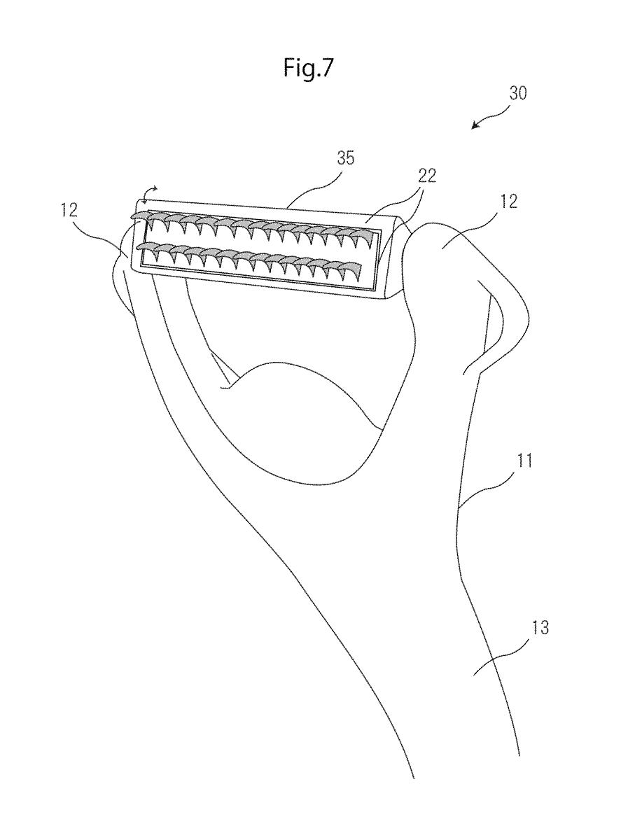

Next, a third embodiment of the present invention will be described. FIG. 7 is a perspective view of a kitchen utensil 30 according to the third embodiment of the present invention. The kitchen utensil 30 according to the present embodiment is different from those of the above embodiments in that the kitchen utensil 30 includes a blade member 35 having a triangular prism shape.

The blade member 35 is a member having a triangular prism shape, and has both ends in a longitudinal direction (a top surface and a bottom surface of the triangular prism) swingably supported by the holding portions 12 through a shaft members (not shown) . Furthermore, the blade member 35 has a double blade 22 having two stacked blades on a front side surface thereof. The side surface on which the blade 22 is formed is supported by the holding portions 12 of the Y-shaped member 11 so as to be protruded forward of the holding portions 12. Thus, application of the blade member 35 to a contact surface A is not hindered by the holding portions 12, and the blade member 35 can make deeper cuts under the contact surface A.

However, the side surface on which the blade 22 is formed may not be necessarily protruded forward of the holding portions 12. When the blade 22 is positioned higher than the holding portions 12, cuts can be made in a contact surface A having a flat shape.

### Fourth Embodiment

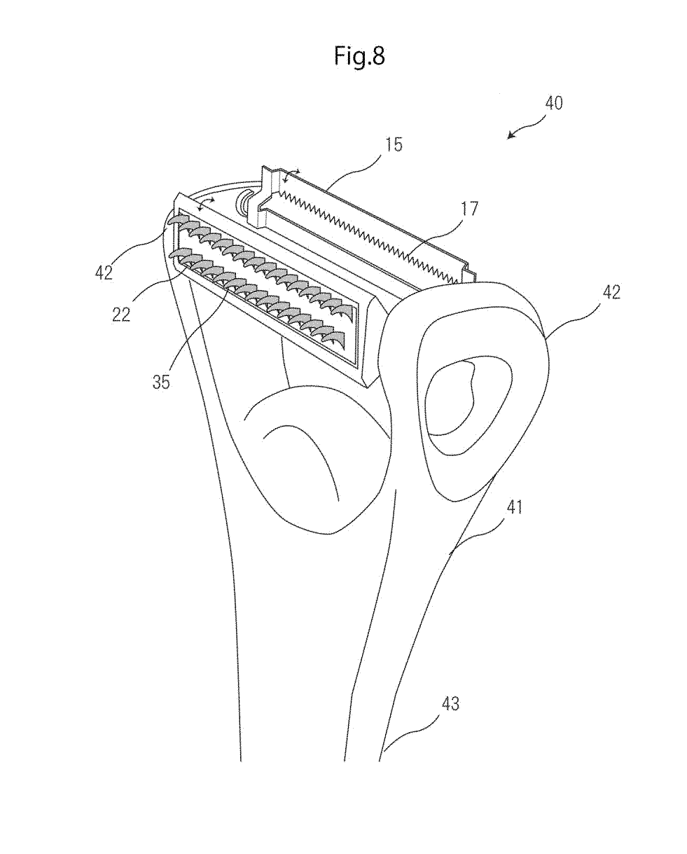

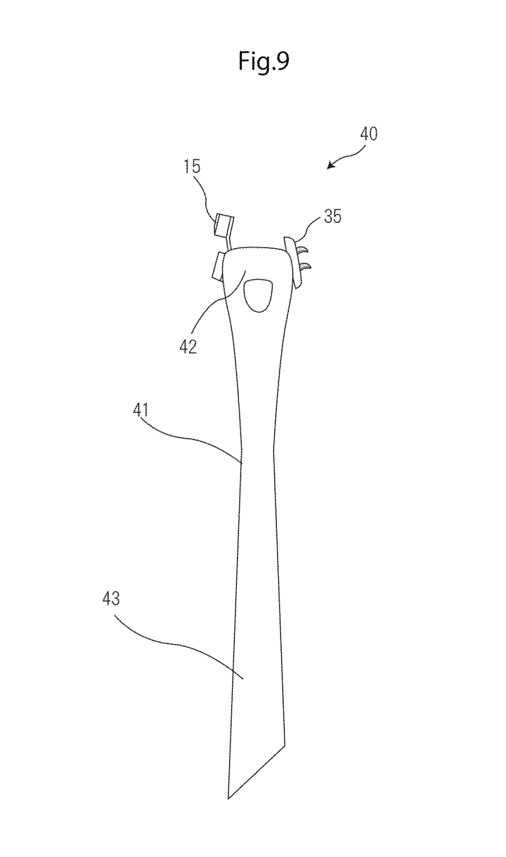

Next, a fourth embodiment of the present invention will be described. FIG. 8 is a perspective view of a kitchen utensil 40 according to the fourth embodiment of the present invention, and FIG. 9 is a side view of the kitchen utensil 40. The kitchen utensil 40 according to the present embodiment is different from those of the above embodiments in that the kitchen utensil 40 has both of the blade member 15 and the blade member 35.

The kitchen utensil 40 has a Y-shaped member 41, the blade member 15, and the blade member 35. The Y-shaped member 41 has holding portions 42, and the blade member 15 and the blade member 35 are supported back to back by the holding portions 42 with the blades of the blade members 15 and 35 facing outward. That is, when one side surface of the Y-shaped member 41 faces an object, the blade member 15 can be used, and when the other side surface faces the object, the blade member 35 can be used. Therefore, the Y-shaped member 41 is formed into a rod-shaped member as illustrated in FIG. 9 so that when the grip portion 43 is gripped by the user, both side surfaces thereof can be easily used.

As in the above embodiments, the blade member 15 and the blade member 35 are supported by the holding portions 42 so that the blade 17 and the blade 22 are protruded forward (here, sides to which the respective blades face) of the Y-shaped member 41. Therefore, even in a case where a contact surface A is wider than a space between the holding portions 42, the application of the blade members 15 and 35 cannot be hindered by the holding portions 42.

Next, an example of chopping by the kitchen utensil 40 having such a configuration will be described. First, the user applies the blade member 35 to press the blade 22 substantially perpendicular to a contact surface, draws the blade 22 in a first direction, and makes cuts. Next, the blade member 35 is turned by approximately 90 degrees, and the same operation is repeated on the same surface. As a result, cuts are made in a second direction substantially perpendicular to the first direction, and a grid-shaped cuts are formed in an object.

Next, the blade member 15 is applied to the contact surface to shave off the grid-shaped cuts formed earlier. Then, the grid-shaped cuts are removed and separated from the object, and thus a material to be cooked can be readily chopped. A size and a depth of a cut to be formed and a shaving thickness can be freely designed according to a shape of the blade member.

The embodiments of the present invention have been described above. Note that the above embodiments are intended to exemplify the gist of the present invention, and does not limit the present invention. Further various modifications and alterations may be made within the technical idea of the present invention. Hereinafter, modifications of the present invention will be described.

First Modification

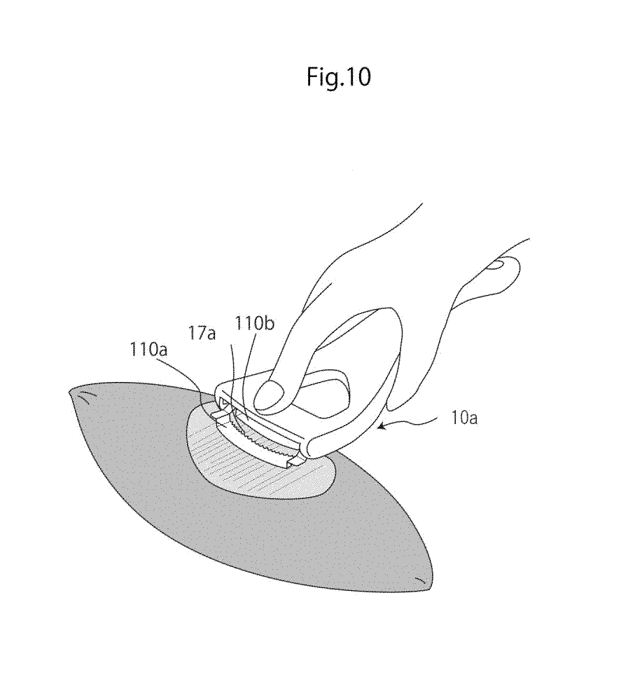

FIG. 10 is a perspective view of a kitchen utensil 10a according to a first modification of the present invention. The kitchen utensil 10a includes an upper section 110a and a lower section 110b which are curved forward. According to such a structure, the deepest cut can be made at the center portion of a blade 17a without hindrance of application. Therefore, cutting can be started from any position of an object. Furthermore, regardless of the shape of the object, cutting is performed without inhibition.

In addition, in the kitchen utensil 10a, a holding portion 12 of the Y-shaped member 11 is positioned in the shape of the upper section 110a and the lower section 110b which are curved, in this configuration, and has a substantially T-shape. Note that, pressing with, for example, finger cushion allows effective application of a force to the blade.

Second Modification

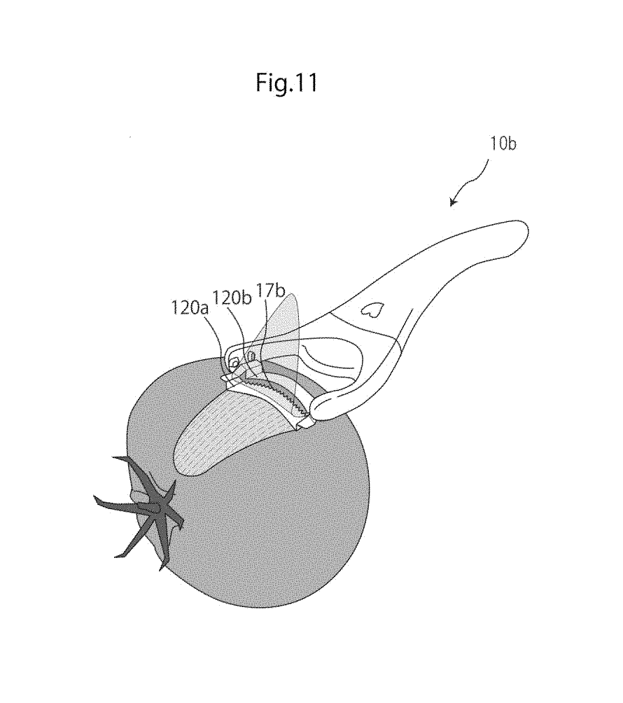

FIG. 11 is a perspective view of a kitchen utensil 10b according to a second modification of the present invention. The kitchen utensil 10b includes an upper section 120a and a lower section 120b which are obtained by curving the upper section 110a and the lower section 110b backward. According to such a structure, a cut can be made in an object having a spherical surface by the blade 17b moving along the curved surface, without hindrance of application.

Third Modification

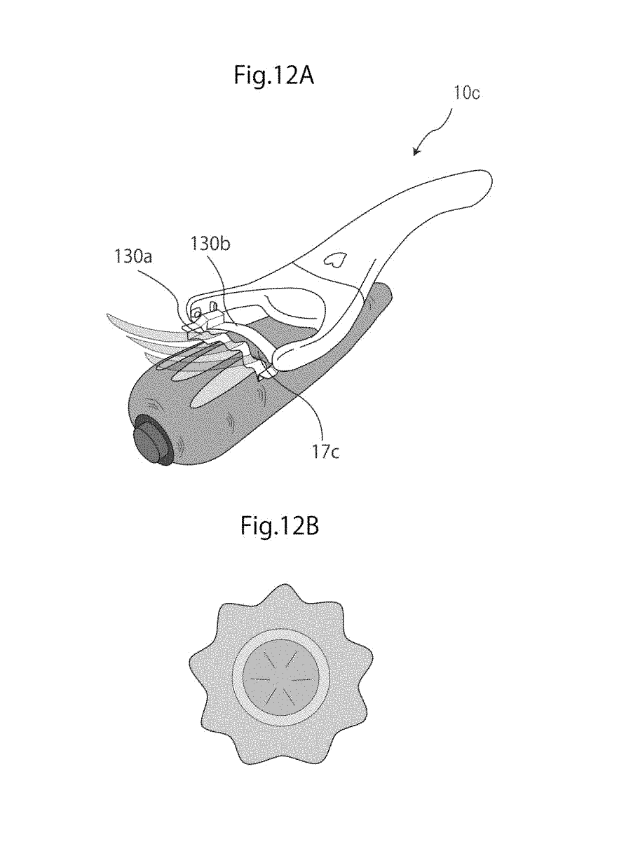

FIG. 12 A is a perspective view of a kitchen utensil 10c according to a third modification of the present invention. The kitchen utensil 10c includes an upper section 130a and a lower section 130b which are obtained by curving the upper section 120a and the lower section 120b backward. Furthermore, the upper section 130a has a blade 17c which is a corrugated blade waving along the backward curvature. According to such a structure, cuts can be made in an object by movement of the blade 17c moving along the curved surface of the object, without hindrance of application. In addition, since a shaved surface has a wavy shape owing to the corrugated blade, a cross-section of the object has a shape as illustrated in FIG. 12B. This configuration enables a decorative recessed cuts simultaneously with peeling.

Note that a surface having the blade may be provided with a cover for protection against unexpected injury upon handling.

In addition, the blades according to the respective embodiments and modifications can be freely combined. For example, the upper or lower section having the raised teeth may be curved. In addition, the corrugated blade may be formed to have a center not curved.

### REFERENCE SIGNS LIST

10, 10a, 10b, 20, 30, 40 KITCHEN UTENSIL
11, 41 Y-SHAPED MEMBER
12, 42 HOLDING PORTION
13, 43 GRIP PORTION
15, 25, 35 BLADE MEMBER
16a, 110a, 120a, 120c UPPER SECTION
16b, 110b, 120b, 130b LOWER SECTION
16c CONNECTING PORTION
16d STEP
17, 17a, 17b, 17c, 22 BLADE
19 SHAFT MEMBER
21 BLADE PLATE
23 RAISED TOOTH

1. A kitchen utensil comprising:
a slender shaped blade member including a long narrow through hole for a cut object to pass through; and
a holding portion supporting both ends in a longitudinal direction of the blade member, wherein
the blade member having two steps which respectively extend forwardly and substantially perpendicularly from the both ends supported by the holding portion, and an upper section connects the two steps, and
a blade is provided at the side of the through hole from one transition portion between the step and the upper section to the other transition portion between the step and the upper section.

2. The kitchen utensil according to claim 1, wherein the blade member has the upper section and a lower section substantially parallel and having a difference in level, and
the upper section is protruded forward of the lower section.

3. (canceled)

4. The kitchen utensil according to claim 2 wherein the blade member further includes a blade at the lower section.

5-10. (canceled)
